(19) United States
(12) Patent Application Publication
(10) Pub. No.: US 2006/0052933 A1
(43) Pub. Date: Mar. 9, 2006

(54) Navigation device and approach information display method

(76) Inventor: Hiroki Ota, Tokyo (JP)

Correspondence Address: RATNERPRESTIA, P O BOX 980, VALLEY FORGE, PA, 19482-0980, US

(21) Appl. No.: 10/542,377

(22) PCT Filed: Jan. 13, 2004
(86) PCT No.: PCT/JP04/00145

§ 371 Date: Jul. 14, 2005

(30) Foreign Application Priority Data
Jan. 14, 2003 (JP) 2003-006011

(51) Int. Cl. G01C 21/36

(52) U.S. Cl. 701/200; 701/211

(57) ABSTRACT

A present position calculating unit calculates a present position, an orientation and a velocity. In the case where a travel road determining unit determines that a road on which a subject vehicle is currently traveling is the mountain road or the narrow road on which visibility is low, the travel road determining unit transmits discrimination information for discriminating the subject vehicle and the present position information to an external server through a communication unit. A route guidance unit searches a crossable place and displays the crossable place on a display unit on the basis of proximity information on an oncoming vehicle which has been received from the server or a subsequent vehicle that gets abnormally closer to the subject vehicle. Two navigation devices may directly exchange the proximity information.

### BACKGROUND OF THE INVENTION

1. Field of the Invention

The present invention relates to a navigation device and a proximity information display method which are capable of giving a user proximity information on another vehicle.

2. Description of the Related Art

Up to now, a navigation device that is mounted on a mobile object such as a vehicle obtains a position of the mobile object by means of a positioning system such as a GPS, and also displays the position of the mobile body on a map that is displayed on a monitor on the basis of road map data as basic functions. Moreover, the navigation device has a function of searching a travel route up to a destination to guide a user into the searched travel route, guiding a user into a travel direction at an intersection, or searching facilities along a travel road to guide the user into the searched facilities. In addition, in recent years, there has been proposed a navigation device that has a function of transmitting individual alarms suitable for the respective vehicles at a location such as the intersection where a large number of accidents occur from a center station on the basis of the obtained positional information with respect to the respective vehicles on which the navigation device is mounted, respectively. The above conventional navigation device is disclosed in, for example, JP 2002-42294A (see page 3 and FIG. 4).

However, although the above conventional navigation device can generate alarms that are different in the contents with respect to the plural vehicles that are traveling in the same direction while being close to each other, there arises such a problem that the conventional navigation device does not take into consideration vicinity information on the vehicles that get closer to each other from the different directions. For example, on a road having adverse conditions such that the visibility is low because the road twists as with a mountain road, and the road is narrow, the dangerousness of collision with another vehicle is high, and the dangerousness of collision can be prevented if the existence of an oncoming vehicle that gets closer to the subject vehicle is known in advance.

The oncoming vehicle can be detected by means of, for example, a millimeter wave radar. However, a system using the millimeter wave radar can determine nothing other than a short distance such as several tens meters. Also, a roadside radio unit is arranged on the road, thereby making it possible to give the travel vehicle the information on the oncoming vehicle through a communication between the road and the vehicle. However, this system is high in the costs and local in the detection area. Also, although the oncoming vehicle can be imaged by means of a video camera, there arises such a problem that a detection system using the video camera cannot be employed in a location where the visibility is low. Further, on the road having the adverse conditions, since there is also the possibility of collision when a subsequent vehicle abnormally gets closer to the subject vehicle, the prevention of collision in advance is required.

### SUMMARY OF THE INVENTION

The present invention has been made to solve the above problems with the related art, and therefore an object of the present invention is to provide a navigation device and a proximity information display method, which suppress the initial costs by diverting the existing device, and also discriminate a mountain road that is high in the dangerousness of collision with another vehicle or a road having adverse conditions such that the visibility is low or the road is narrow in advance, thereby making it possible to prevent the dangerousness in advance.

In order to achieve the above object, according to one aspect of the present invention, there is provided a navigation device comprising: present position calculating means for calculating present position information of a subject device; road determining means for determining a feature of a road on which the subject device is currently traveling according to map data; communication means for transmitting discrimination information for discriminating the subject device and the present position information to an external server and for receiving proximity information on another device from the server according to the feature of the road; and display means for displaying the proximity information on the other device which is received from the server. With the above structure, the initial costs are suppressed by diverting the existing device that is the navigation device. Also, in the case where the subject vehicle is traveling on a mountain road or a road having adverse conditions such that the visibility is low or the road is narrow, the proximity information on the oncoming vehicle that gets closer to the subject vehicle or the subsequent vehicle that abnormally gets closer to the subject vehicle is acquired from the server in real time and then displayed, thereby making it possible to prevent the dangerousness of collision with another vehicle and also making it possible to reduce a burden on a driver.

Also, in the navigation device according to the present invention, when the road determining means determines that the road on which the subject device is traveling is the road that is low in visibility, the communication means transmits the discrimination information and the present position information to the server. With the above structure, in the case where the information is unnecessary from the viewpoint of safety, since the communication means does not transmit the discrimination information and the present position information to the server, the necessary information can be acquired only when the information is necessary.

Further, in the navigation device according to the present invention, the present position information that is transmitted by the communication means includes orientation information and velocity information. With the above structure, the server can produce the proximity information on another vehicle by adding the orientation information and the velocity information to the present position information, thereby making it possible that a user acquires the proximity information that is high in precision.

Further, in the navigation device according to the present invention, the present position information that is transmitted by the communication means includes error information of at least one of the position information, the orientation information and the velocity information. With the above information, the server can produce the proximity information on another vehicle by adding the error information to the present position information, thereby making it possible that the user acquires the proximity information that is high in safety.

Further, in the navigation device according to the present invention, the present position information that is transmitted by the communication means includes destination spot information. With the above structure, the server determines whether both of the subject vehicle and another vehicle travel on the same route or not, on the basis of the destination information, thereby making it possible to produce the proximity information on those vehicles.

Further, in the navigation device according to the present invention, the communication means uses mobile communication that enables packet communication. With the above structure, the characteristic of the packet communication system which transmits and receives a small amount of data only when the data is necessary can be leveraged.

Further, the navigation device according to the present invention further comprises route guidance means for searching a place at which the subject device can cross the other device from map data and guides the user into the place when receiving the proximity information of the other device from the server. With the above structure, the user can wait for passage of the oncoming vehicle or the abnormally approaching vehicle at the most crossable place, thereby making it possible that the subject vehicle safely crosses the oncoming vehicle or the abnormally approaching vehicle.

Further, in the navigation device according to the present invention, when the route guidance means searches the crossable place, the route guidance means takes into consideration at least one of a travel direction, a distance to the crossable place from the subject vehicle, and a total of turn and twist angles as a parameter. With the above structure, the user is prevented from being guided into a crossing place that is opposite in the travel direction and large in the total of turn and twist angles and difficult in the driving operation even if the distance to that place is relatively short, and can wait or cross at an optimum crossable place.

Further, according to another aspect of the present invention, there is provided a server comprising: communication means for communicating with a plurality of navigation devices described above; and proximity information preparing means which receives discrimination information and present position information from the plurality of navigation devices for preparing proximity information indicative of the possibility that a specific navigation device crosses another navigation device on the basis of the discrimination information and the present position information of the plurality of navigation devices to transmit the proximity information to the specific navigation device. With above structure, the server produces the proximity information on the devices crossing each other on the basis of the present position information collected from the plurality of navigation devices, and can transmit the proximity information to only the specific navigation device that has the possibility of crossing another navigation device and will receive information supply service from the server.

Further, in the server according to the present invention, the proximity information preparing means processes, by priority, reception from the navigation device that is high in a predetermined priority. With the above structure, in the case where the user selects the higher priority, it is possible to give the proximity information according to a request from the user and also to process the vehicle that is high in the importance such as the proximity of an emergency vehicle by priority.

Further, according to still another aspect of the present invention, there is provided a proximity information display method, comprising: calculating present position information of a subject device; determining a type of a road on which the subject device is traveling according to map data; transmitting discrimination information for discriminating the subject device and the present position information to an external server; receiving proximity information on another device from the server; searching a place at which the subject device can cross the other device from the map data when receiving the proximity information on the other device from the server; and displaying the searched crossable place together with proximity information on the other device on the map. With the above method, in the case where the subject device is traveling on a mountain road or a road having adverse conditions such that the visibility is low or the road is narrow, the proximity information on the oncoming vehicle that gets closer to the subject vehicle or the subsequent vehicle that abnormally gets closer to the subject vehicle is acquired from the server in real time and then displayed, thereby making it possible to prevent the dangerousness of collision with another vehicle and also making it possible to reduce a burden on a driver.

Further, according to still another aspect of the present invention, there is provided a navigation device comprising: present position calculating means for calculating present position information on a subject vehicle; road determining means for determining a feature of a road on which the subject vehicle is currently traveling according to map data; communication means for transmitting discrimination information for discriminating the subject device and the present position information on the subject device to another device and for receiving discrimination information for discriminating the other device and the present position information on the other device from the other device in the case where the road determining means determines that the feature of the road is a road having an adverse condition; and display means for displaying the present position information on the other device that is received from the other device. With the above structure, the initial costs are suppressed by diverting the existing device that is the navigation device. Also, in the case where the subject vehicle is traveling on a mountain road or a road having adverse conditions such that the visibility is low or the road is narrow, the proximity information on the oncoming vehicle that gets closer to the subject vehicle or the subsequent vehicle that abnormally gets closer to the subject vehicle is acquired from another device in real time and then displayed, thereby making it possible to prevent the dangerousness of collision with another vehicle and also making it possible to reduce a burden on a driver.

Further, in the navigation device according to the present invention, the present position information that is transmitted by the communication means includes orientation information and velocity information. With the above structure, the proximity information that adds the orientation information and the velocity information to the present position information can be received from another device, thereby making it possible that a user acquires the proximity information that is high in precision.

Further, in the navigation device according to the present invention, the present position information that is transmitted by the communication means includes error information of at least one of the position information, the orientation information and the velocity information. With the above information, another device can produce the proximity information by adding the error information to the present position information, thereby making it possible that the user acquires the proximity information that is high in safety.

Further, in the navigation device according to the present invention, the present position information that is transmitted by the communication means includes destination spot information. With the above structure, another device determines whether both of the subject vehicle and another vehicle travel on the same route or not, on the basis of the destination information, thereby making it possible to produce the proximity information on those vehicles.

Further, in the navigation device according to the present invention, the communication means uses mobile communication that enables packet communication. With the above structure, the characteristic of the packet communication system which transmits and receives a small amount of data only when the data is necessary can be leveraged.

Further, the navigation device according to the present invention further comprises route guidance means for searching a place at which the subject device can cross the other device from map data and guides the user into the place when receiving the present position information of the other device. With the above structure, the user can wait for passage of the oncoming vehicle or the abnormally approaching vehicle at the most crossable place, thereby making it possible that the subject vehicle safely crosses the oncoming vehicle or the abnormally approaching vehicle.

Further, in the navigation device according to the present invention, when the route guidance means searches the crossable place, the route guidance means takes into consideration at least one of a travel direction, a distance to the crossable place from the subject vehicle, and a total of turn and twist angles as a parameter. With the above structure, the user is prevented from being guided into a crossing place that is opposite in the travel direction and large in the total of turn and twist angles and difficult in the driving operation even if the distance to that place is relatively short, and can wait or cross at an optimum crossable place.

According to the present invention, the feature of the road on which the subject device is traveling is determined according to the map data, and the discrimination information for discriminating the subject device and the present position information are transmitted directly to the external server or another device, and the proximity information on the other device is received directly from the server or other device and displayed. As a result, the initial costs are suppressed by diverting the existing device that is the navigation device. Also, in the case where the subject vehicle is traveling on a mountain road or a road having adverse conditions such that the visibility is low or the road is narrow, the proximity information on the oncoming vehicle that gets closer to the subject vehicle or the subsequent vehicle that abnormally gets closer to the subject vehicle is acquired from the server or the other device in real time and then displayed, thereby making it possible to prevent the dangerousness of collision with another vehicle and also making it possible to reduce a burden on a driver.

The above object and advantages of the present invention will become more apparent by the following embodiments that will be described with reference to the accompanying drawings.

### BRIEF DESCRIPTION OF THE DRAWINGS

These and other objects and advantages of this invention will become more fully apparent from the following detailed description taken with the accompanying drawings in which:

FIG. 1 is a block diagram showing the outline structure of a navigation device according to a first embodiment of the present invention;

FIG. 2 is a flowchart showing a proximity information display process of another vehicle in the navigation device according to the first embodiment of the present invention;

FIG. 3 is a block diagram showing the outline structure of a navigation device according to a second embodiment of the present invention; and

FIG. 4 is a flowchart showing a proximity information display process of another vehicle in the navigation device according to the second embodiment of the present invention.

### DETAILED DESCRIPTION OF THE PREFERRED EMBODIMENTS

Now, a description will be given in more detail of preferred embodiments of the present invention with reference to the accompanying drawings.

### First Embodiment

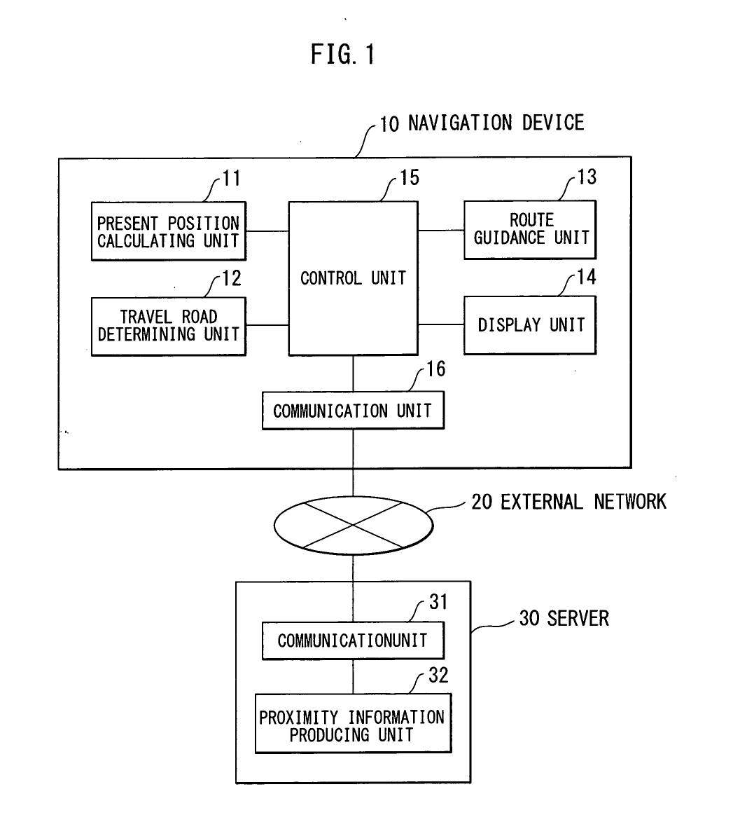

FIG. 1 is a block diagram showing the outline structure of a navigation device according to a first embodiment of the present invention. In a navigation device 10, a present position calculating unit 11 calculates the present position, the velocity and the orientation of a vehicle through a GPS receiver, a vehicle velocity sensor, an angular velocity gyro, and a method such as map matching with map data base. A travel road determining unit 12 determines features of the present travel road, more specifically, whether the present travel road is a mountain road or not, whether the present travel road is low in the visibility or not, or whether the present travel road has adverse conditions such that the visibility is low and the road is narrow or not, according to the GPS measurement results, and the road type, the road width, the junction angle of plural road links, the number of intersections, the radius curvature of a curve, the altitude data, and the travel locus of the map data in the vicinity of the travel direction. A route guidance unit 13 searches a guidance route up to a destination that is set by a user. Also, the route guidance unit 13 extracts a crossable place such as a place at which the road width is widened, a parking zone, a roadside zone, a shelter, a store or facilities on the guidance route from the map data. Then, the route guidance unit 13 calculates the costs together with a total of turn and twist angles up to the crossable place on the basis of the position and orientation of the subject vehicle, and guides the subject vehicle to a place at which the subject vehicle more easily arrives. A display unit 14 displays a travel route on a map on a liquid crystal monitor on the basis of the map data, and also displays necessary information by characters. A control unit 15 that is formed of a microcomputer controls the entire device, and stores discrimination information such as the registered number of the respective vehicles or ID number for specifying the navigation device. A communication unit 16 communicates with a server 30 through an external network 20 such as internet by means of mobile communication that enables packet communication such as PHS, cellar phone or satellite telephone. The packet communication can transmit and receive a small amount of data only if the data is necessary. The server 30 that is formed of a microcomputer includes a communication unit 31 that communicates with the navigation devices of the respective vehicles through the network 20. The server 30 also includes a proximity information preparing unit 32 that detects an oncoming vehicle that gets closer to the subject vehicle or a subsequent vehicle that abnormally gets closer to the subject vehicle according to the discrimination information and the present position information which are received from the navigation devices 10 of the respective vehicles, and produce proximity information. Then, the server 30 transmits the proximity information to a specific navigation device 10. The specific navigation device is directed to a navigation device that contracts a supply service of at least proximity information from the server 30.

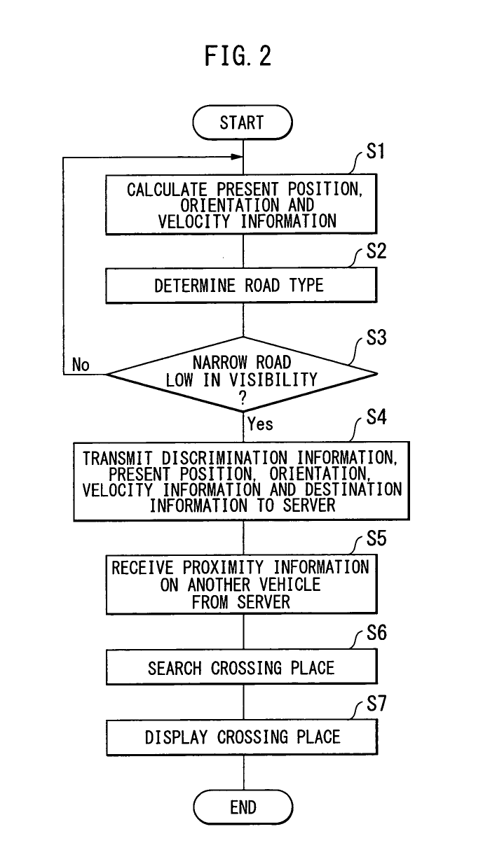

Subsequently, the operation in this embodiment will be described with reference to FIG. 2. The navigation device 10 that is mounted on each of the vehicles calculates the present position, the orientation and the velocity of the vehicle by the present position calculating unit 11, and transmits the calculated results to the control unit 15 (Step S1). In this situation, the navigation device 10 also calculates the error information of the present position, the orientation and the velocity in addition to those parameters. Then, the travel road determining unit 12 determines the features of the road on which the subject vehicle is currently traveling (Step S2). In the case where the road is a mountain road or a narrow road that is low in the visibility (Step S3), the travel road determining unit 12 produces the transmission data and transmits the transmission data to the server 30 through the external network 20. In the transmission of the transmission data to the server 30, the control unit 15 produces the transmission data in a given format on the basis of the discrimination information such as the ID number for specifying the subject vehicle or the navigation device, the calculated present position, orientation and velocity, and their error information, and the destination information that is set in the route guidance unit 15. Then, the control unit 15 transmits the transmission data to the communication unit 16, and the communication unit 16 transmits the transmission data to the server 30 through the external network 20 in a given procedure (Step S4). When the communication unit 31 of the server 30 receives the transmission data from each of the vehicles, the proximity information preparing unit 32 determines the possibility that the respective vehicles cross each other according to the discrimination information, the present position, the orientation, the velocity, their error information, and the destination information which are successively obtained from the respective vehicles. Then, the proximity information preparing unit 32 estimates the possibility that the respective vehicles cross each other on the basis of a route distance difference, an orientation difference, and the error information between the respective vehicles, and the information on whether those vehicles being contracted between the users or not. Then, the proximity information preparing unit 32 transmits the transmission data through the external network 20 only to a specific vehicle that contracts the proximity information on other vehicles. The proximity information that is transmitted from the server 20 includes the present position information, the orientation information and the velocity information on other information. When the navigation device 10 of the specific vehicle receives the proximity information (Step S5), the route guidance unit 13 searches a crossable place such as a place at which the road width is widened, a parking zone, a roadside zone, a shelter, or an intersection on the travel route to the destination from the map data. Then, the route guidance unit 13 calculates the costs together with a total of turn and twist angles up to the crossable place on the basis of the present position and orientation of the subject vehicle, selects the most reachable spot, and transmits the selected spot to the control unit 15 (Step S6). When searching the crossable place, the route guidance unit 13 takes at least one of the distance and the total of turn and twist angles up to the crossable place in the travel direction or from the subject vehicle as the parameter into consideration. The crossable place is predetermined, for example, such that the crossable place exists in the travel direction or is closest from the position of the subject vehicle, or the total of turn and twist angles is equal to or less than a given value. As a result, the user is prevented from being guided into a crossing place that is opposite in the travel direction and large in the total of turn and twist angles and difficult in the driving operation even if the distance to that place is relatively short, and can wait or cross another vehicle at an optimum crossable place. The control unit 15 displays the selected spot on the map that is displayed on the display unit 14 (Step S7). The display unit 14 displays a position of the crossable place, and an estimated remaining period of time and an estimated distance up to the crossable place together with the present position information, the orientation information and the velocity information of another vehicle which have been received from the server 20.

As described above, according to this embodiment, in the case where the subject vehicle is traveling on a mountain road or a road having adverse conditions such that the visibility is low or the road is narrow, the information on the oncoming vehicle that gets closer to the subject vehicle is received from the server, and the spot at which the subject vehicle crosses the oncoming vehicle is searched and displayed. As a result, the dangerousness can be prevented with a sufficient allowance for the distance and time, thereby making it possible to reduce a burden on the driver. Also, the same alarm as that described above can be issued with respect to the user in a vehicle that abnormally gets closer to the subject vehicle from the backward in the same direction.

In the above embodiment, in the case where the discrimination information that is transmitted from the respective vehicles includes the priority information, the server 30 conducts the processing according to the priority order, and the processing for the user who has set the higher priority is conducted by priority. Also, in the case where the vehicle such as an emergency vehicle which is higher in the priority gets closer to the subject vehicle, or in the case where the vehicle that gets closer to the subject vehicle at an abnormally higher speed, the processing is conducted by priority.

Also, in the above embodiment, in the case where the navigation devices 10 of the respective vehicles apply systems different in the map data base, respectively or systems having no map data, it is possible that the present position calculating unit 11 successively transmits only the present position information, the orientation information and the velocity information which are obtained by a self-contained navigation to the server, and the server specifies a road on which the respective vehicles are traveling.

Also, in the above embodiment, the route guidance unit 13 searches a place at which the subject vehicle can cross another vehicle. As a simple device, only the proximity information that has been received from the server 20 may be displayed on the display unit 14 with omission of the above processing in the route guidance unit 13.

### Second Embodiment

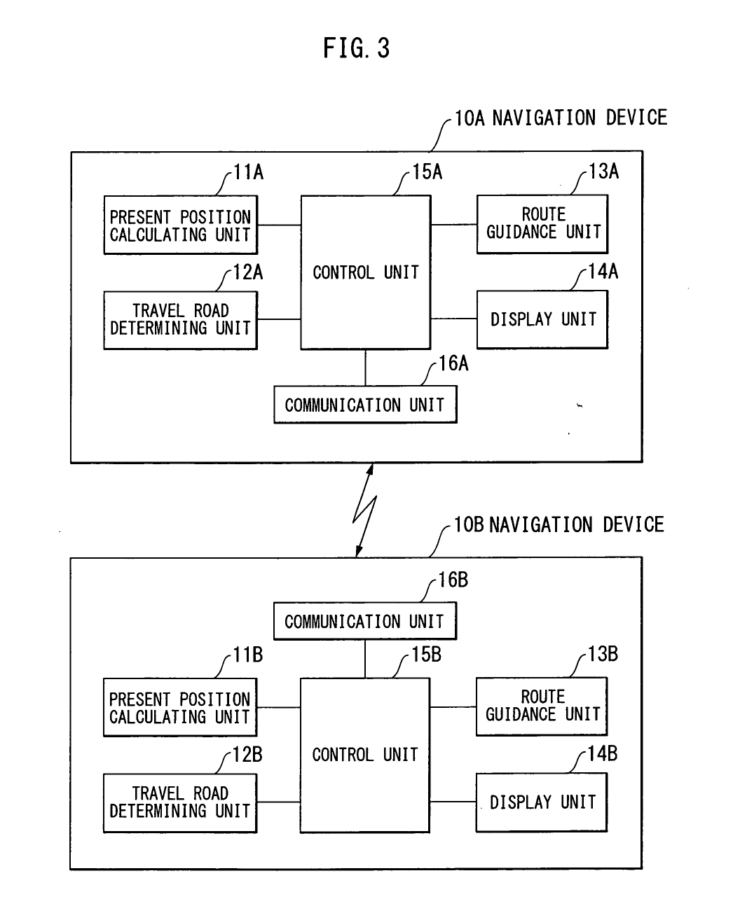

Subsequently, a second embodiment of the present invention will be described below. A navigation device according to the second embodiment of the present invention acquires the proximity information by allowing the navigation devices 10A and 10B to communicate directly with each other, as shown in FIG. 3. The structures of navigation devices 10A and 10B are substantially identical with the navigation device 10 shown in FIG. 1. In the second embodiment, respective communication units 16A and 16B are radio units each having a communication area of, for example, about 2.5 Km in radius, and the other structures are identical with those in FIG. 1. Therefore, the duplicated description of the structure will be omitted, and only its operation will be described below.

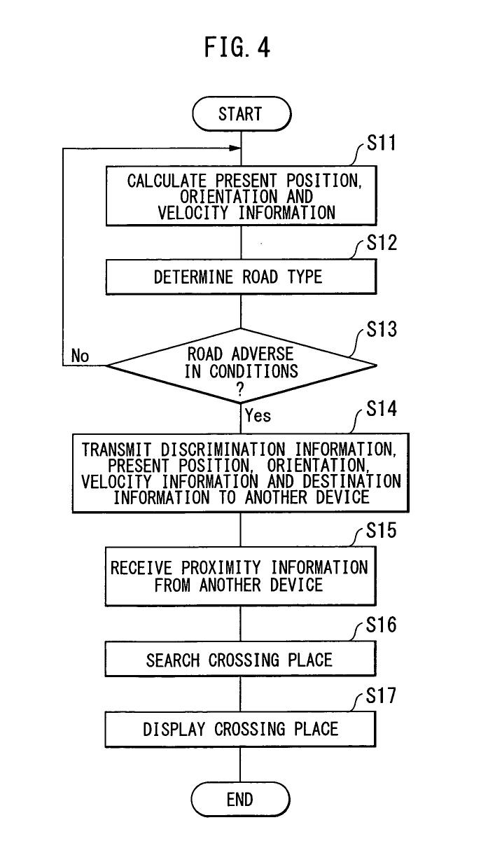

FIG. 4 is a flowchart for explanation of the operation in the second embodiment. In this example, a description will be given of a case in which the navigation device 10A transmits the position information to the navigation device 10B that is another device, and the navigation device 10B produces the proximity information on the basis of the position information and returns the proximity information to the navigation device 10A. Each of the navigation devices 10A and 10B calculates the present position, the orientation and the velocity of the vehicle through each of present position calculating units 11A and 11B, and then transmits the calculated results to control units 15A and 15B (Step S11). In this situation, each of the navigation devices 10A and 10B calculates error information of the present position, the orientation and the velocity in addition to those parameters. Subsequently, each of travel road determining units 12A and 12B determines the features of a road on which the vehicles are currently traveling (Step S12). In the case where the road is a mountain road or a road having adverse conditions such that the visibility is low and the road is narrow (Step S13), the navigation device 10A produces the transmission data, and then transmits the transmission data to another device that exists within an area of 2.5 km in radius from the subject vehicle. In this example, it is assumed that the navigation device 10B exists as another device. In the transmission of the transmission data to the navigation device 10B, the control unit 15A of the navigation device 10A produces the transmission data in a given format on the basis of the discrimination information such as the ID number for specifying the subject vehicle or the navigation device, the calculated present position, orientation and velocity, and their error information, and the destination information that has been set in the route guidance unit 15A. Then, the communication unit 16A transmits the transmission data to the navigation device 10B in a given procedure (Step S14). When the communication unit 16B of the navigation device 10B receives the transmission data from the navigation device 10A, the control unit 15B produces the proximity information for transmission in a given format on the basis of the discrimination information such as the ID number for specifying the subject vehicle or the navigation device, the calculated present position, orientation and velocity, and their error information, and the destination information that has been set in the route guidance unit 15B, and transmits them to the communication unit 16B. Then, the communication unit 16B adds the discrimination information on the navigation device 10A to the proximity information, and then transmits the proximity information with the discrimination information to the navigation device 10A in a given procedure. When the navigation device 10A receives the proximity information (Step S5), the route guidance unit 13 searches a crossable place such as a place at which the road width is widened, a parking zone, a roadside zone, a shelter, or an intersection on the travel route to the destination from the map data. Then, the route guidance unit 13 calculates the costs together with a total of turn and twist angles up to the crossable place on the basis of the present position and orientation of the subject vehicle, selects the most reachable spot, and transmits the selected spot to the control unit 15A (Step S16). When searching the crossable place, the route guidance unit 13 takes into consideration at least one of the distance and the total of turn and twist angles up to the crossable place in the travel direction or from the subject vehicle as the parameter. The crossable place is predetermined, for example, such that the crossable place exists in the travel direction or is closest from the position of the subject vehicle, or the total of turn and twist angles is equal to or less than a given value. As a result, the user is prevented from being guided into a crossing place that is opposite in the travel direction and large in the total of turn and twist angles and difficult in the driving operation even if the distance to that place is relatively short, and can wait or cross another vehicle at an optimum crossable place. The control unit 15A displays the selected spot on the map that is displayed on the display unit 14A (Step S17). The display unit 14A displays a position of the crossable place, and an estimated remaining period of time and an estimated distance up to the crossable place together with the present position information, the orientation information and the velocity information which have been received from the navigation device 10B. It is preferable that the steps S16 and S17 are conducted in the navigation device 10B, likewise.

The above description is given of an example in which the navigation device 10A transmits the position information to the navigation device 10B that is another device, and the navigation device 10B produces the proximity information on the basis of the position information and returns the proximity information to the navigation device 10A. Conversely, the completely same procedure is applied to a case in which the navigation device 10B transmits the position information to the navigation device 10A that is another device, and the navigation device 10A produces the proximity information on the basis of the position information and returns the proximity information to the navigation device 10B.

As described above, according to the second embodiment, in the case where the subject vehicle is traveling on a mountain road or a road having adverse conditions such that the visibility is low or the road is narrow, the information on the oncoming vehicle that gets closer to the subject vehicle is received from the oncoming vehicle, and the spot at which the subject vehicle crosses the oncoming vehicle is searched and displayed. As a result, the dangerousness can be prevented with a sufficient allowance for the distance and time, thereby making it possible to reduce a burden on the driver. Also, the same alarm as that described above can be issued with respect to the user in another vehicle that abnormally gets closer to the subject vehicle from the backward in the same direction.

In the above respective embodiments, the navigation device that is mounted on the vehicle was described. Alternatively, an emergency vehicle message vehicle terminal device having the same navigation function may be used, or a portable navigation device may be used.

As was described above, the navigation device according to the present invention determines a feature of a road on which the subject device is currently traveling according to map data, and transmits discrimination information for discriminating the subject device and the present position information directly to an external server or another device. The navigation device then receives proximity information on another device directly from the server or another device, and displays the proximity information. As a result, the initial costs can be suppressed by diverting the existing device that is the navigation device.

Also, in the case where the subject vehicle is traveling on a mountain road or a road having adverse conditions such that the visibility is low or the road is narrow, the proximity information on the oncoming vehicle that gets closer to the subject vehicle or the subsequent vehicle that abnormally gets closer to the subject vehicle is acquired from the server or another device in real time and then displayed. As a result, it is possible to prevent the dangerousness of collision with another vehicle, and also it is possible to reduce a burden on a driver.

From the above advantages, the proximity information on another vehicle is useful as the navigation device that gives the user the proximity information on another vehicle.

The present invention was described on the basis of the preferred embodiments shown in the drawings. However, it is apparent that the present invention can be easily variously varied or modified by an ordinary skilled man without deviating from the concept of the present invention. The present invention also encompasses such modified examples.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A navigation device comprising:
present position calculating means for calculating present position information of a subject device;
road determining means for determining a feature of a road on which the subject device is currently traveling according to map data;
communication means for transmitting discrimination information for discriminating said subject device and said present position information to an external server and for receiving proximity information on another device from said server according to said feature of the road; and
display means for displaying the proximity information on the other device which is received from said server.

2. The navigation device according to claim 1, wherein when said road determining means determines that the road on which the subject device is traveling is the road that is low in visibility, the communication means transmits said discrimination information and the present position information to said server.

3. The navigation device according to claim 1, wherein said present position information that is transmitted by the communication means includes orientation information and velocity information.

4. The navigation device according to claim 2, wherein said present position information that is transmitted by the communication means includes orientation information and velocity information.

5. The navigation device according to claim 3, wherein said present position information that is transmitted by the communication means includes error information of at least one of the position information, the orientation information and the velocity information.

6. The navigation device according to claim 1, wherein said present position information that is transmitted by the communication means includes destination spot information.

7. The navigation device according to claim 1, wherein said communication means uses mobile communication that enables packet communication.

8. The navigation device according to claim 1, further comprising route guidance means for searching a place at which the subject device can cross said other device from map data and guides a user to the place when receiving the proximity information on the other device from said server.

9. The navigation device according to claim 8, wherein when the route guidance means searches said crossable place, the route guidance means takes into consideration at least one of a travel direction, a distance to the crossable place from the subject vehicle, and a total of turn and twist angles as a parameter.

10. A server comprising:
communication means for communicating with a plurality of navigation devices described in claim 1; and
proximity information preparing means which receives discrimination information and present position information from said plurality of navigation devices for preparing proximity information indicative of the possibility that a specific navigation device crosses another navigation device on the basis of the discrimination information and the present position information of said plurality of navigation devices to transmit the proximity information to said specific navigation device.

11. The server according to claim 10, wherein said proximity information preparing means processes, by priority, reception from the navigation device that is high in a predetermined priority.

12. A proximity information display method, comprising:
calculating present position information of a subject device;
determining a type of a road on which the subject device is traveling according to map data;
transmitting discrimination information for discriminating said subject device and said present position information to an external server;
receiving proximity information on another device from said server;
searching a place at which the subject device can cross the other device from the map data when receiving the proximity information on said other device from said server; and
displaying said searched crossable place together with the proximity information on said other device on the map.

13. A navigation device comprising:
present position calculating means for calculating present position information on a subject vehicle;
road determining means for determining a feature of a road on which the subject vehicle is currently traveling according to map data;
communication means for transmitting discrimination information for discriminating said subject device and the present position information on said subject device to another device and for receiving discrimination information for discriminating said other device and the present position information on said other device from said other device in the case where the road determining means determines that the feature of the road is a road having an adverse condition; and
display means for displaying the present position information on said other device that is received from said other device.

14. The navigation device according to claim 13, wherein said present position information that is transmitted by the communication means includes orientation information and velocity information.

15. The navigation device according to claim 14, wherein said present position information that is transmitted by the communication means includes error information of at least one of the position information, the orientation information and the velocity information.

16. The navigation device according to claim 13, wherein said present position information that is transmitted by the communication means includes destination spot information.

17. The navigation device according to claim 13, wherein said communication means uses mobile communication that enables packet communication.

18. The navigation device according to claim 13, further comprising route guidance means for searching a place at which the subject device can cross said other device from map data and guides a user to the place when receiving the present position information of said other device.

19. The navigation device according to claim 18, wherein when the route guidance means searches said crossable place, the route guidance means takes into consideration at least one of a travel direction, a distance to the crossable place from the subject vehicle, and a total of turn and twist angles as a parameter.

20. The navigation device according to claim 4, wherein said present position information that is transmitted by the communication means includes error information of at least one of the position information, the orientation information and the velocity information.
